(19) United States
(12) Patent Application Publication
(10) Pub. No.: US 2022/0038293 A1
(43) Pub. Date: Feb. 3, 2022

(54) OPTICAL CODE CREATION PROGRAM, OPTICAL CODE READING AUTHENTICATION PROGRAM, OPTICAL CODE AUTHENTICATION SYSTEM, PAYMENT SYSTEM, PRINTED ARTICLE PRODUCTION METHOD, AND OPTICAL CODE AUTHENTICATION METHOD

(71) Applicant: TERRARA CODE RESEARCH INSTITUTE INC., Aichi (JP)

(72) Inventor: Nobuyuki TERAURA, Aichi (JP)

(21) Appl. No.: 17/459,692

(22) Filed: Aug. 27, 2021

Related U.S. Application Data
(63) Continuation of application No. PCT/JP2020/007808, filed on Feb. 26, 2020.

(30) Foreign Application Priority Data
Feb. 28, 2019 (JP) 2019-035464

(51) Int. Cl. H04L 9/32; H04L 9/30; G06Q 20/32; G06K 7/14; G06K 19/06

(52) U.S. Cl. CPC H04L 9/3247; H04L 9/3263; G06K 19/06037; G06Q 20/3274; G06K 7/1417; H04L 9/30

(57) ABSTRACT

The present invention increases the ease of use of an optical code in which an digital signature is recorded. Recorded in the optical code are: a message; an digital signature created from the message using a creator's secret key; and a public key ID with which it is possible to specify the creator's public key certificate that includes a public key paired with the secret key, said ID being smaller in size than the public key certificate. An optical code readout authentication device, after reading the optical code, acquires the creator's public key certificate from a certificate provision server on the basis of the recorded public key ID, and uses the public key certificate to authenticate the optical code.

### RELATED APPLICATION

This application is a Continuation Application of International Application No. PCT/JP2020/7808, filed Feb. 26, 2020, which claims priority to Japan Application No. 2019-35464, filed Feb. 28, 2019. The subject matter of each is incorporated herein by reference in entirety.

### TECHNICAL FIELD

The present invention relates to a method for exchanging highly reliable data by using an optical code in which an digital signature is recorded.

### BACKGROUND ART

In recent years, optical codes such as a QR code® are used to provide guides to various websites and the like. However, criminal acts using such optical codes have been reported. In these acts, false optical codes are used to provide guides to fraud websites where credit card numbers and passwords are acquired illegally or trading money is stolen. In order to prevent such criminal acts, it has been proposed to embed an digital signature into the optical code and verify a creator of the optical code and presence or absence of data falsification on the basis of the digital signature (for example, Patent Literature 1, 2). In optical codes disclosed in Patent Literature 1, 2, a QR code is subjected to mask treatment, or a QR code module is converted into a multivalued module, so as to expand a QR code recording area and record an digital signature in the expanded area.

### CONVENTIONAL ART DOCUMENT

### Patent Literature

Patent Literature 1: JP-2016-6945 A

Patent Literature 2: Japanese Patent No. 6403085

### SUMMARY OF INVENTION

### Technical Problem

By the way, when data with the digital signature is sent via the Internet, it is common to attach an electronic certificate that includes a public key corresponding to the digital signature. However, it is difficult to record the electronic certificate in normal data capacity of the optical code. Accordingly, in order to verify an issuance source or verify the presence or the absence of the data falsification by using the optical code disclosed in Patent Literature 1 or 2, it is presumed that a reading device of the optical code acquires the electronic certificate (a public key certificate) corresponding to the digital signature of the optical code in advance. However, the reading device cannot handle the plural issuance sources.

The present invention has been made in view of such a circumstance and therefore has a purpose of improving convenience of an optical code in which an digital signature is recorded.

### Solution to Problem

The present invention is an optical code creation program for causing a computer to execute: digital signature creation processing to create an digital signature from a message by using a secret key of a creator of an optical code; and optical code creation processing to create the optical code in which the message, the digital signature, and a public key ID with which a public key certificate of the creator can be specified and which is smaller in size than the public key certificate are recorded, the public key certificate including a public key that is paired with the secret key. Here, the “message” is not limited to a character string and includes all types of data that is recorded in the general optical code.

The public key certificate itself is not recorded in the optical code that is created by the optical code creation program of the present invention. However, a reader of said optical code can specify the public key certificate of the creator of the optical code on the basis of the public key ID recorded in the optical code. Accordingly, even in the case where the reader of the optical code does not possess the public key certificate of the creator of the optical code, it is possible to authenticate the creator of the optical code and confirm presence or absence of message falsification by acquiring the required public key certificate from outside via a communication line and verifying the digital signature recorded in the optical code.

Just as described, according to the present invention, even in the case where the reader does not prepare the public key certificate of the creator of the optical code, or even in the case where the public key certificate is not recorded in the optical code, it is possible to authenticate the optical code on the basis of the public key ID and the digital signature. Here, the public key ID suffices when the public key certificate can be specified with the public key ID. In addition, compared to the public key certificate that includes identification information, the public key, and the like of the creator, the public key ID data is small in size and thus can be recorded with the message in the optical code in general capacity without any problem. Therefore, according to the optical code creation program of the present invention, it is possible to improve convenience of the optical code with the digital signature.

It is proposed that, in the present invention, the optical code includes a light module identified in a light color and a dark module identified in a dark color, at least a part of the light module and the dark module is a multivalued module that can store two or more bits by having plural types of light reflective properties and/or by being subdivided into minute areas, the optical code includes: a first recording area where data is recorded in a pattern of the light module and the dark module; and a second recording area where data is recorded in a pattern of the multivalued module, and in the optical code creation processing, the digital signature is recorded in the second recording area, and the message and an index indicating that the digital signature is recorded in the second recording area are recorded in the first recording area.

The optical code that is created by using such an optical code creation program can be compatible with the general optical code. That is, a reading device for the general optical code that does not have a verification function of the digital signature can read the message itself.

In addition, it is proposed that, in the above configuration, the dark module is subdivided into plural submodules, each of the plural submodules is in one of plural types of dark colors with the different light reflective properties, and in the second recording area, the data is recorded according to a coloration pattern of the submodules.

The optical code that is created by using such an optical code creation program can secure sufficient capacity for recording the digital signature in the second recording area.

It is proposed that, in the present invention, the optical code includes: a variable area where a pattern of the light module and the dark module varies by the data recorded in the first recording area; and a fixed area where the pattern of the light module and the dark module is determined in advance and which constitutes a pattern assisting with optical reading, the second recording area has: a variable second recording area where the data is recorded according to a coloration pattern of the submodules in the dark module included in the variable area; and a fixed second recording area where the data is recorded according to a coloration pattern of the submodules in the dark module included in the fixed area, and in the optical code creation processing, the data and error correction data of the data are recorded in each of the variable second recording area and the fixed second recording area, and sizes of the data and the error correction data, which are recorded in each of the variable second recording area and the fixed second recording area, are recorded in an area where the message is not recorded in the first recording area.

The optical code that is created by using such an optical code creation program can create a newly independent recording area in the fixed area. In addition, the data recorded in the second recording area can be read on the basis of the data recorded in the first recording area.

In addition, it is proposed that, in the above configuration, the error correction data is a Reed-Solomon code, and in the optical code creation processing, the size of the error correction data recorded in each of the variable second recording area and the fixed second recording area is determined according to recordable size of the error correction data in each of the variable second recording area and the fixed second recording area so as to maximize correction capability.

With the optical code that is created by such an optical code creation program, it is possible to enhance the correction capability of the optical code as much as possible.

Another aspect of the present invention is a program for causing a computer to read an optical code in which a message, an digital signature created from the message by using a secret key of a creator of the optical code, and a public key ID with which a public key certificate of the creator including a public key paired with the secret key can be specified are recorded. The optical code reading authentication program causes the computer to execute: image acquisition processing to acquire image data of the optical code that is captured by an imaging device installed in or connected to the computer; reading processing to read the message, the digital signature, and the public key ID recorded in the optical code on the basis of the image data acquired in the image acquisition processing; certificate acquisition processing to acquire the public key certificate from a specified certificate provision server via a communication line on the basis of the public key ID read in the reading processing; verification processing to verify the digital signature recorded in the optical code on the basis of the public key certificate that corresponds to the public key ID recorded in the optical code; and reading authentication result output processing to output the message and identification information of the creator included in the public key certificate in the case where it is determined that the digital signature is normal in the verification processing.

According to such an optical code reading authentication program, it is possible to confirm identification of the creator of the optical code and the presence or the absence of the message falsification by using the computer having a communicating function such as a smartphone or a tablet computer. Therefore, it is possible to reliably prevent impersonation of the creator of the optical code and the message falsification. In particular, with such a configuration, the public key certificate of the creator of the optical code can be acquired from the certificate provision server on the basis of the public key ID. Therefore, there is an advantage that it is possible to handle authentication of the optical codes that are created by a large number of the creators.

A further another aspect of the present invention is a program for causing a computer to read an optical code in which a message, an digital signature created from the message by using a secret key of a creator of the optical code, and a public key ID with which a public key certificate of the creator including a public key paired with the secret key can be specified are recorded. The optical code reading authentication program causes the computer to execute: image acquisition processing to acquire image data of the optical code that is captured by an imaging device installed in or connected to the computer; reading processing to read the message, the digital signature, and the public key ID recorded in the optical code on the basis of the image data acquired in the image acquisition processing; certificate confirmation processing to determine whether the public key certificate that corresponds to the public key ID read in the reading processing is stored in a storage of the computer; verification processing to verify the digital signature recorded in the optical code on the basis of the public key certificate that corresponds to the public key ID recorded in the optical code; and reading authentication result output processing to output the message and identification information of the creator included in the public key certificate in the case where it is determined that the digital signature is normal in the verification processing.

According to such an optical code reading authentication program, in the case where the public key certificates of the plural creators are stored in the computer in advance, it is possible to authenticate the optical codes that are created by a specified number of the creators even when the computer is offline. In addition, even when the computer is online, a time required for the authentication can be reduced by authenticating the optical code by using the stored public key certificates.

In addition, it is proposed that, in the case where the message includes a web address, in the reading authentication result output processing, the web address and the identification information of the creator included in the public key certificate are output to a display screen of the computer, and a user of the computer confirms whether to access the web address.

According to such an optical code reading authentication program, it is possible to easily confirm reliability of the web address that is recorded in the optical code. Therefore, it is possible to favorably prevent a phishing scam and the like.

A further another aspect of the present invention is an optical code authentication system including: a computer in which the optical code creation program is installed; a computer in which the optical code reading authentication program is installed; and a certificate provision server that links and stores the public key certificate with the public key ID and, in response to a request from an external computer, sends the public key certificate that corresponds to the public key ID included in the request to the computer via a communication line.

With such an optical code authentication system, it is possible to easily detect that a false optical code shown by impersonation of the creator and a forged optical code in which the message is falsified are not valid.

A further another aspect of the present invention is an optical code authentication system including: a reading device that reads an optical code in which a message, an digital signature created from the message by using a secret key of a creator of the optical code, and a public key ID with which a public key certificate of the creator including a public key paired with the secret key can be specified are recorded, and that outputs the read message, the read digital signature, and the read public key ID; and an authentication device that receives the message, the digital signature, and the public key ID output from the reading device and authenticates the optical code. The authentication device has: a function of acquiring, from a specified certificate provision server, the public key certificate that corresponds to the public key ID via a communication line and verifying the digital signature recorded in the optical code by using the public key certificate; and a function of outputting identification information of the creator included in the public key certificate in the case where a verification result of the digital signature is normal.

Also with such an authentication system, it is possible to easily detect that the false optical code presented by the impersonation of the creator and the forged optical code in which the message is falsified are not valid.

A further another aspect of the present invention is a payment system including: a payment server; a payment optical code in which payment information of a payment receiver is recorded; and a payment terminal of a payer that stores payment information of the payer, reads the payment optical code, and requests the payment server for payment from the payer to the payment receiver. In the payment optical code, the payment information of the payment receiver, an digital signature that is created from the payment information of the payment receiver by using a secret key of the payment receiver, and a public key ID with which a public key certificate of the payment receiver including a public key paired with the secret key can be specified are recorded. A certificate provision server is provided to link and store the public key certificate with the public key ID and, in response to a sending request from the payment terminal, send the public key certificate that corresponds to the public key ID included in the sending request to the payment terminal. The payment terminal can read the payment optical code, and includes: public key acquisition means capable of acquiring the public key certificate, which corresponds to the public key ID read from the payment optical code, from the certificate provision server via a communication line; authentication means that authenticates the payment optical code on the basis of the digital signature and the payment information of the payment receiver that are recorded in the payment optical code and on the basis of the public key certificate that corresponds to the public key ID recorded in the payment optical code; receiver information showing means that shows identification information of the payment receiver included in the public key certificate on a display screen and requests confirmation of the payment receiver in the case where the authentication means authenticates the payment optical code correctly; and payment request means capable of requesting the payment server for payment to the payment receiver in the case where the payer approves the payment receiver shown by the receiver information showing means.

With such a system, it is possible to prevent the payer from making the payment to a third party that differs from the payment receiver by replacement of the payment optical code.

A further another aspect of the present invention is a printed article production method including: a step of creating an digital signature from printing data that is printed on a printing target by using a secret key of a creator of an optical code; a step of creating an optical code in which the printing data, the digital signature, and a public key ID with which a public key certificate of the creator including a public key paired with the secret key can be specified and which is smaller in size than the public key certificate are recorded; a step of printing the printing data on the printing target; and a step of printing the optical code on the printing target. Here, the step of printing the printing data on the printing target and the step of printing the optical code on the printing target may be executed simultaneously.

On the printed article that is produced by such a production method, the printing data printed on the printed article is also recorded in the optical code printed on the printed article. Such an optical code includes the digital signature and the public key ID, and it is possible to confirm the creator and the presence or the absence of the falsification of the message (the printing data) with such an optical code. Accordingly, on such a printed article, it is possible to confirm that the printing data is not falsified by comparing the printing data recorded in the optical code with the printing data printed on the printed article. Therefore, according to such a printed article production method, it is possible to prevent distribution of a forged printed article in which the printing data is falsified.

A further another aspect of the present invention is an optical code authentication method including: a step of linking and registering a public key ID with a public key certificate in a certificate provision server; a step of creating an digital signature from a message by using a secret key of a creator; a step of creating an optical code in which the message, the digital signature, and the public key ID with which a public key certificate of the creator including a public key paired with the secret key can be specified and which is smaller in size than the public key certificate are recorded; a step of producing a printed article added with the optical code; a step of disclosing the printed article; a step of causing a computer to read the message, the digital signature, and the public key ID recorded in the optical code; a step of causing the computer to request the certificate provision server for the public key certificate, which corresponds to the public key ID read from the optical code, via a communication line; a step of causing the certificate provision server to send the public key certificate to the computer via the communication line; a step of causing the computer to determine whether the optical code is created by an owner of the public key certificate on the basis of the digital signature and the message recorded in the optical code and on the basis of the public key certificate; and a step of causing the computer to output the message and identification information of the creator included in the public key certificate in the case where it is determined that the optical code is created by the owner of the public key certificate. Here, the “step of disclosing the printed article” is a step of sending the printed article to the reader or posting the printed article such that the reader of the optical code can read the optical code.

According to such an optical code authentication method, there is no need to send the public key certificate of the creator of the optical code to the reader in advance or record the public key certificate in the optical code, and it is possible to authenticate the optical code with the digital signature on the reader side of the optical code.

In the optical code authentication method of the present invention, it is proposed that the message is a web address. In such a case, it is possible to easily confirm the reliability of the web address that is recorded in the optical code. Therefore, it is possible to favorably prevent the phishing scam and the like.

In the optical code authentication method of the present invention, it is proposed that the message includes a part or a whole of characters and/or numbers printed on the printed article. In such a case, it is possible to confirm that the characters and the numbers printed on the printed article are not falsified by authenticating the optical code with the digital signature. Therefore, it is possible to prevent the distribution of the forged printed article in which the printing data is falsified.

In the optical code authentication method of the present invention, it is proposed that the message is payment information of a payment receiver. In such a case, the payment optical code can easily be authenticated. Therefore, it is possible to favorably prevent such a criminal act that the payer makes the payment to the third party that differs from the payment receiver by using the false payment optical code.

### Advantageous Effects

As it has been described so far, according to the present invention, it is possible to improve the convenience of the optical code with the digital signature.

### BRIEF DESCRIPTION OF DRAWINGS

FIG. 1(a) is a schematic view of a signature optical code 1, and FIG. 1(b) is an explanatory view in which areas of the signature optical code 1 are divided and patterned per function.

FIG. 2 is an explanatory view illustrating coloration patterns of a dark module 2b.

FIG. 3(a) is a table illustrating data recorded in a first recording area, and FIG. 3(b) is a table illustrating data recorded in a second recording area.

FIG. 4 is an explanatory view illustrating a procedure of a method for authenticating the signature optical code 1.

FIG. 5 is an explanatory view illustrating the procedure of the method for authenticating the signature optical code 1 following FIG. 4.

FIG. 6 is a flowchart illustrating processing contents of an optical code reading authentication program.

FIG. 7(a) illustrates a pamphlet on which the signature optical code 1 is recorded, and FIG. 7(b) illustrates a display example of a reading result of the signature optical code 1 that is shown on a display screen of a signature optical code reading authentication device 26.

FIG. 8(a) illustrates a certificate of a qualification on which the signature optical code 1 is printed, and FIG. 8(b) illustrates a display example of a reading result of the signature optical code 1 shown on a display screen of the signature optical code reading authentication device 26.

FIG. 9 is a flowchart illustrating processing contents of a payment program.

FIG. 10 is a flowchart of a display example of an access confirmation screen.

### DESCRIPTION OF EMBODIMENTS

A description will hereinafter be made on an embodiment of the present invention with reference to the following examples.

### EXAMPLE 1

This Example relates to an optical code authentication system that allows a reader of an optical code with an digital signature (hereinafter also abbreviated as a “signature optical code”) to authenticate a message recorded in the signature optical code and a creator of the signature optical code by using the signature optical code.

The optical code authentication system in this Example uses a public key infrastructure (PKI) and includes: a signature optical code creation device used by the creator of the signature optical code (hereinafter also simply referred to as the “creator”); a signature optical code reading authentication device used by the reader of the signature optical code (hereinafter also simply referred to as the “reader”); and a certificate provision server that provides the reader with public key certificates of the plural creators via the Internet.

In the optical code authentication system of this Example, the creator uses the signature optical code creation device to create the signature optical code in which a message to be carried to the reader, the digital signature created from the message on the basis of a secret key of the creator, and a public key ID used by the reader to specify the public key certificate of the creator are recorded. Here, the public key ID is smaller in size than the public key certificate that includes identification information and the public key of the creator. The signature optical code creation device is constructed of a computer in which a dedicated optical code creation program is installed.

When reading the signature optical code, the signature optical code reading authentication device of the reader specifies the public key certificate of the creator on the basis of the recorded public key ID. In the case where the signature optical code does not include the public key certificate, the signature optical code reading authentication device acquires the public key certificate from the certificate provision server. Then, the signature optical code reading authentication device uses the public key certificate to verify the digital signature recorded in the signature optical code, then authenticates the creator of the signature optical code, and checks presence or absence of message falsification. The signature optical code reading authentication device is constructed of a computer in which a dedicated optical code reading authentication program is installed. More specifically, a communication terminal, such as a smartphone or a tablet computer, having a communicating function and an imaging function is preferred as the signature optical code reading authentication device.

As described above, in the optical code authentication system of this Example, there is no need to record the public key certificate in the signature optical code in order for the reader to specify the public key certificate of the creator via the public key ID. Since the public key ID can be smaller in size than the public key certificate, recording of the public key ID and the message in the existing general optical code does not cause a problem. In addition, in the optical code authentication system of this Example, since the reader can acquire the public key certificate of the creator via the Internet, the reader does not have to possess the public key certificate of the creator in advance. Therefore, in the optical code authentication system of this Example, the reader can easily authenticate the signature optical codes created by a large number of the creators.

Next, a description will be made on a specification of the signature optical code that is used in the optical code authentication system of this Example.

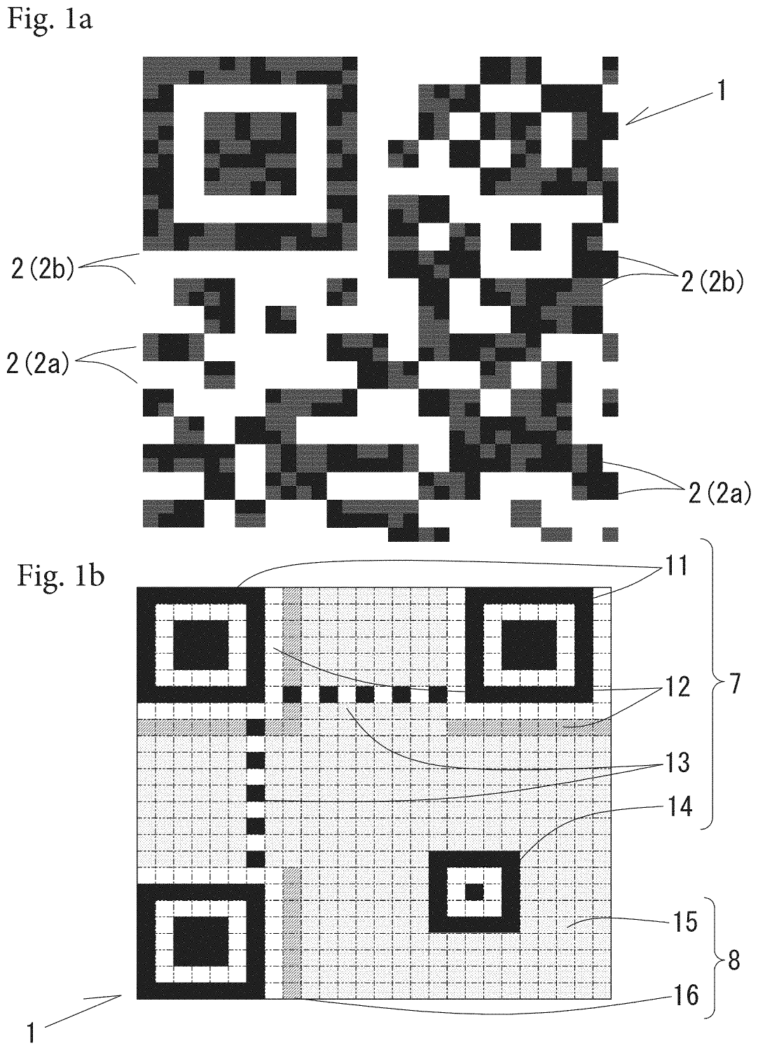

In this Example, as illustrated in FIG. 1, a signature optical code 1 that is compatible with a QR code® is used. That is, a basic configuration of the signature optical code 1 satisfies QR code standards. More specifically, as illustrated in FIG. 1(a), the signature optical code 1 has 25 square modules 2 per row and per column, and these modules 2 are arranged in a matrix. The modules 2 of the signature optical code 1 include light modules 2a in a light color (white) and dark modules 2b in a dark color (black). As illustrated in FIG. 1(b), the signature optical code 1 includes a function pattern 7 and an encoded area 8. The function pattern 7 is an area where coloration patterns of the modules 2 are determined in advance, and includes: a position detection pattern 11 that assists in optical reading of the signature optical code 1, a separation pattern 12, a timing pattern 13, an alignment pattern 14, and the like. The encoded area 8 is an area where data is recorded according to the coloration pattern of each of the modules 2, and includes a data code area 15 where a data code language and an error correction code language are recorded, and a format information code area 16 where codes indicative of format information and model information are arranged. In other words, the fixed area according to the present invention corresponds to the function pattern 7, and the variable area according to the present invention corresponds to the encoded area 8. These configurations comply with JIS standards for the QR code (JIS X 0510: 2004), and thus a detailed description thereon will not be made.

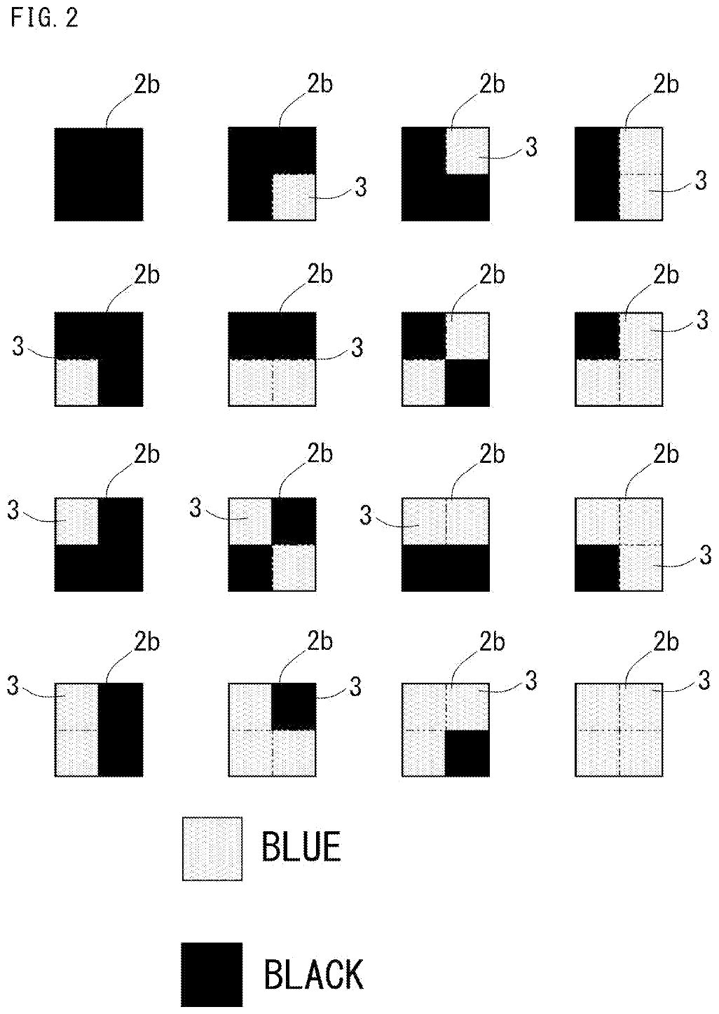

In this Example, as illustrated in FIG. 2, each of the dark modules 2b in the signature optical code 1 is subdivided into four submodules 3 by vertical and horizontal center lines. Each of the submodules 3 can be colored in black or blue, and the dark module 2b can have any of 16 patterns according to the coloration of the four submodules 3. That is, the dark module 2b is a multivalued module capable of further recording four-bit data by the coloration patterns of the submodules 3.

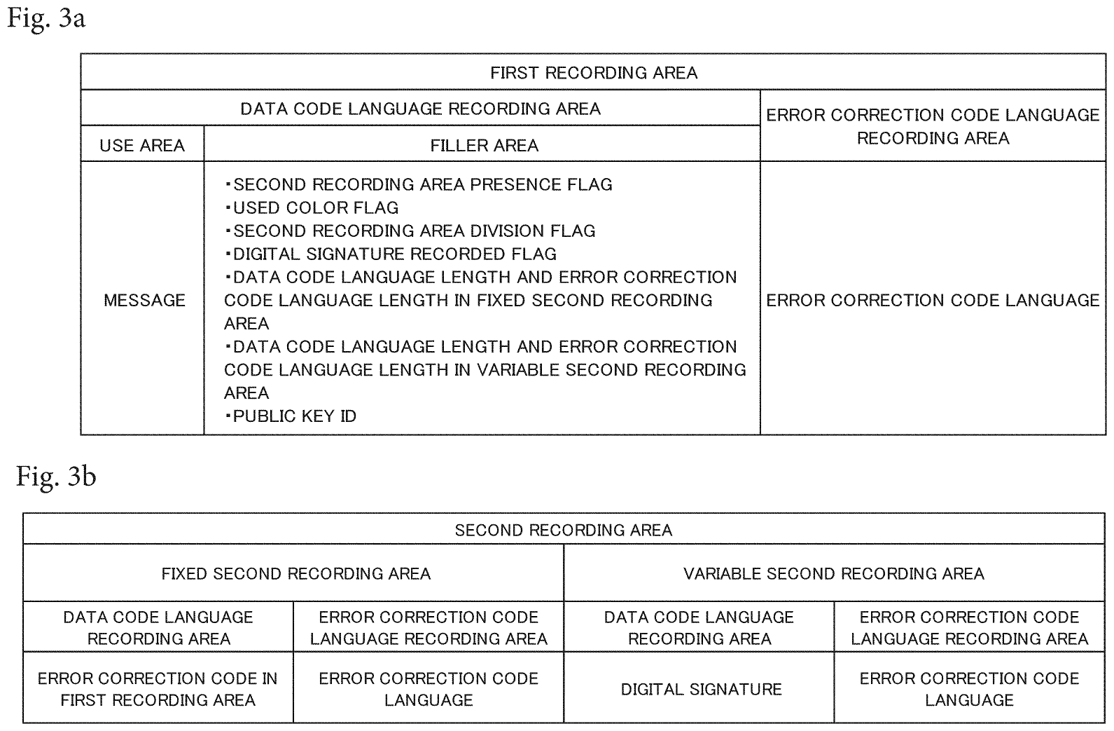

As illustrated in FIG. 3, a data recording area of the signature optical code 1 is largely divided into a first recording area and a second recording area. The first recording area is an area where the data is recorded according to the patterns of the light modules 2a and the dark modules 2b in the data code area 15. The first recording area is divided into a data code language recording area for recording the data code language in accordance with the QR code standards and an error correction code language recording area for recording the error correction code language. Here, in the QR code standards, the data code language recording area includes a filler area where the data is not recorded in a remaining portion after the rest of the portion (a use area) is used to record the data code language. In this Example, additional data is recorded in such a filler area. That is, the data code language recording area in the first recording area is divided into the use area and the filler area.

The second recording area is an area where the data is recorded according to the patterns of the submodules 3 in the dark modules 2b. In addition, the second recording area is largely divided into a fixed second recording area and a variable second recording area. The fixed second recording area is an area where the data is recorded according to the coloration patterns of the submodules 3 in the dark modules 2b constituting the function pattern 7. The variable second recording area is an area where the data is recorded according to the coloration patterns of the submodules 3 in the dark modules 2b constituting the encoded area 8. Similar to the first recording area, each of the fixed second recording area and the variable second recording area is provided with the data code language recording area for recording the data code language and the error correction code language recording area for recording the error correction code language to correct the data code language. Here, a ratio of the number of the dark modules 2b constituting the function pattern 7 to the number of the modules in the signature optical code 1 is stable. However, a ratio of the number of the dark modules 2b constituting the encoded area 8 to the number of modules in the signature optical code 1 is variable according to the data recorded in the first recording area. Thus, capacity of the variable second recording area varies according to contents of recorded data in the first recording area.

In the signature optical code 1, the message is recorded in the use area of the first recording area. A content of the message to be carried to the reader is not particularly limited. An example of the typical message is a web address. In daily life, the optical codes are widely used to guide the communication terminals to the websites. However, a criminal act of impersonating the creator and creating a forged optical code to guide the communication terminal to a malicious website is concerned. Thus, necessity of authenticating the optical code in which the web address is recorded is high.

As illustrated in FIG. 3, the following data (1) to (8) is recorded as the additional data in the filler area of the first recording area.

(1) Second recording area presence flag (1 bit)

The second recording area presence flag is an index indicating presence of the second recording area. That is, it is possible to identify whether the read optical code is the normal QR code or the optical code equipped with the second recording area by determining a value of such a flag. In a case of the signature optical code 1, the flag is always “1” (the second recording area is present).

(2) Used color flag (1 bit)

The used color flag is an index indicating the coloration pattern of the submodules. When the submodules are colored in black and blue, the used color flag is “0”. When the submodules are colored in two types of black with different infrared light reflective properties, the used color flag is “1”. The latter is configured that the coloration pattern of the submodules cannot be identified without use of a dedicated imaging device. As will be described below, in the optical code authentication system of this Example, the smartphone or the like is used as a reading device of the signature optical code 1. Thus, the submodules 3 are colored in black and blue.

(3) Second recording area division flag (1 bit)

When the second recording area is divided into the fixed second recording area and the variable second recording area, the second recording area division flag is “1”. When the second recording area is not divided into the fixed second recording area and the variable second recording area, the second recording area division flag is “0”.

(4) Digital signature recorded flag (1 bit)

The digital signature recorded flag is an index indicating whether the digital signature is recorded in the second recording area. In a case of the signature optical code 1 of this Example, the flag is always “1” (the digital signature is present).

(5) Data code language length and error correction code language length in fixed second recording area (2 bytes)

(6) Data code language length and error correction code language length in variable second recording area (2 bytes)

(7) Public key ID (4 bytes)

The public key ID is not limited to an ID that is recorded in the public key certificate by the issuance source (an authentication authority) of the public key certificate. The public key ID only needs to be an ID with which the public key certificate of the creator can be specified in the system. The public key ID may be a simple serial number. In such a case, a prescribed public key certificate to be used in the system can desirably be acquired from a prescribed certificate provision server in the system. Meanwhile, in the case where the public key certificate that can be provided differs by the certificate provision server, the public key ID is desirably a combination of identification information of the certificate provision server capable of providing the public key ID and the serial number. Required size for the public key ID varies by the number of the public key certificates managed by the system. However, when the size is four bytes, a unique ID can be assigned to each of the public key certificates in the world. The general public key certificate is about 1K bytes in size, and each of the digital signature and the public key of the Elliptic Curve DSA used in this Example is 40 bytes in size. Accordingly, the public key ID is much smaller than the public key certificate and can be generated in smaller size than the digital signature and the public key.

As illustrated in FIG. 3, the error correction code language of the first recording area is recorded in the fixed second recording area, and the digital signature is recorded in the variable second recording area. The digital signature is basically issued by using a hash function to create a digest of the message to be recorded in the first recording area and encrypting the digest with the secret key of the creator of the signature optical code 1. Such digital signature is a well-known technique used for the public key infrastructure, and thus a detailed description thereon will not be made. In this Example, the digital signature is issued by the ECDSA. This is because the digital signature by the ECDSA is small in size (40 bytes) and thus is suited for recording in the signature optical code.

In the case where the module number of the signature optical code 1 is 25 per column and 25 per row as illustrated in FIG. 1, the message of about 10 bytes and the public key ID of 4 bytes can be recorded in the first recording area according to the QR code standards in an error correction level M, and the digital signature of 40 bytes can be recorded in the second recording area.

When the signature optical code 1 in this Example is read by a general QR code reading device, the light modules 2a are identified as light modules, and the dark modules 2b are identified as dark modules. This is because a QR code reading program identifies lightness/darkness of each of the modules 2 only by a reflective property (luminosity) of visible light. Since the patterns of the light modules 2a and the dark modules 2b in the signature optical code 1 are based on the QR code standards, the QR code reading device reads the message recorded in the first recording area from the identified patterns of the light modules 2a and the dark modules 2b. Meanwhile, in the QR code, the data is not recorded in the filler area. Thus, the additional data recorded in the filler area of the first recording area is not read by the QR code reading device. As described above, although the message in and the creator of the signature optical code 1 according to this Example cannot be authenticated, the message therein can be read by using the existing QR code reading device, and thus the signature optical code 1 is compatible with the QR code.

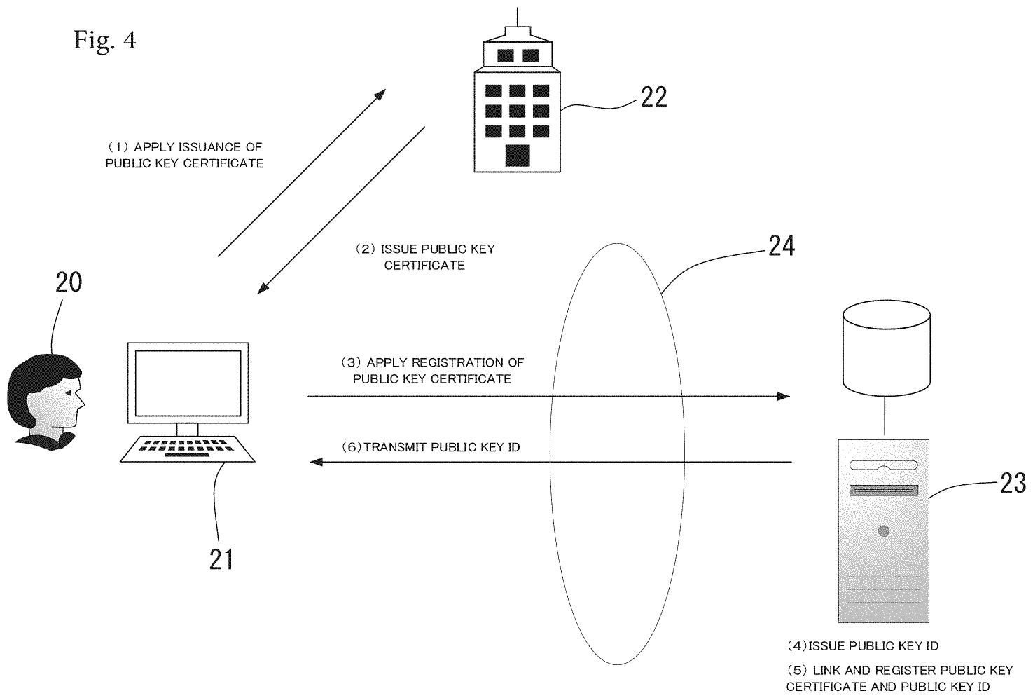

A description will be made on a specific example of an optical code authentication method by the optical code authentication system in this Example. First, prior to creation of the signature optical code 1, a creator 20 stores an own secret key and an own public key ID in a signature optical code creation device 21. More specifically, as illustrated in FIG. 4, the creator 20 applies issuance of the public key certificate to an authentication operator of the public key infrastructure (an authentication authority 22) (FIG. 4 (1)) and acquires the own public key certificate and the own secret key (FIG. 4 (2)). Next, the creator 20 applies registration of the own public key certificate to operating business of the certificate provision server 23 via the Internet 24 (FIG. 4 (3)). The operating business issues the public key ID corresponding to the public key certificate of the creator 20 (FIG. 4 (4)), links and stores the public key certificate with the public key ID in the certificate provision server 23 (FIG. 4 (5)), and transmits the public key ID to the creator 20 who has applied for registration (FIG. 4 (6)). Then, the creator 20 stores the own secret key and the own public key ID that are acquired in the signature optical code creation device 21. However, the method for acquiring the secret key and the public key ID illustrated in FIG. 4 merely constitutes one example. For example, in the case where the authentication operator (the authentication authority 22) is also the operating business of the certificate provision server 23, the authentication operator may link and store the public key ID with the public key certificate in the certificate provision server 23 upon issuance of the public key certificate of the creator 20 and may send, to the creator 20, the public key ID together with the public key certificate and the secret key. In addition, the ID that is assigned to the public key certificate by the authentication operator issuing the public key certificate may be used as the public key ID.

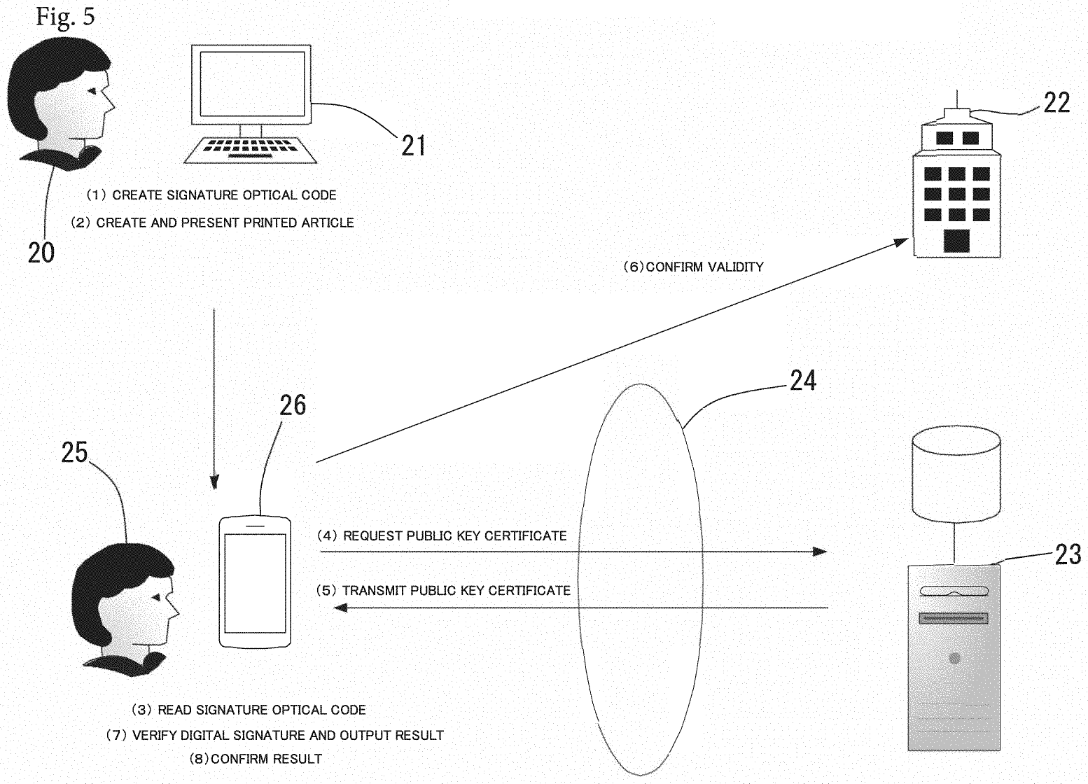

After the public key ID and the public key certificate are stored in the certificate provision server 23 and the creator 20 stores the own secret key and the own public key ID in the signature optical code creation device 21, the signature optical code 1 is authenticated in steps illustrated in (1) to (8) of FIG. 5.

Details of each of the steps (1) to (8) are as follows.

(1) The creator 20 creates the signature optical code 1 in which the required message, the digital signature, and the own public key ID are recorded by using the signature optical code creation device 21.

(2) The creator 20 produces a printed article added with the created signature optical code 1, sends the printed article, or posts the printed article to disclose the signature optical code 1 to a particular or non-particular reader 25.

(3) The reader 25 reads the data recorded in the signature optical code 1 by using a signature optical code reading authentication device 26.

(4) The signature optical code reading authentication device 26 requests, via the Internet 24, the certificate provision server 23 for the public key certificate that corresponds to the public key ID recorded in the signature optical code 1.

(5) The certificate provision server 23 sends the requested public key certificate to the signature optical code reading authentication device 26. Here, in the case where the signature optical code reading authentication device 26 stores the public key certificate corresponding to the public key ID in a storage, the processing in (4) and the processing in (5) are unnecessary.

(6) The signature optical code reading authentication device 26 requests the authentication authority 22 to confirm validity of the public key certificate.

(7) The signature optical code reading authentication device 26 verifies the digital signature by using the public key certificate corresponding to the public key ID and outputs a verification result. That is, abnormality is found in the verification result, an error message is displayed. Meanwhile, in the case where the verification result is normal, the authentication of the signature optical code 1 has been succeeded. Thus, the message recorded in the signature optical code 1 and identification information of an owner (the creator) included in the public key certificate are shown on a display screen.

(8) The reader 25 confirms the verification result output by the signature optical code reading authentication device 26.

As described above, according to the optical code authentication method in this Example, there is no need to send the public key certificate of the creator 20 of the signature optical code 1 to the reader 25 in advance or record the public key certificate in the signature optical code 1, and it is possible for the reader 25 to authenticate the signature optical code 1.

As described above, in this Example, the signature optical code creation device 21 is constructed of the computer in which the dedicated optical code creation program is installed. Such an optical code creation program creates the signature optical code 1 by causing the computer to execute processing in (1) to (5) below. Here, the processing in (2) corresponds to the digital signature creation processing according to the present invention, and the processing in (3) to (8) corresponds to the optical code creation processing according to the present invention.

(1) Acquire the message to be recorded in the signature optical code 1.

(2) Create the digital signature from the message by using the secret key of the creator that has been acquired in advance.

(3) Determine the size of the signature optical code (a version of the QR code) according to the message size.

(4) Determine the data code language length and the error correction code language length in the fixed second recording area and the variable second recording area. Here, the data code language length is determined by the size of the data that is recorded in each of the recording areas. The error correction code language length is determined to have the maximum size that can be recorded in the rest of the portion other than the data code language recording portion in each of the recording areas. This is because the error correction code language is a Reed-Solomon code and correction capability is improved with an increase in the size of the error correction code language.

(5) Determine the value of the flag recorded in the filler area.

(6) Determine the data to be recorded in the first recording area and the second recording area.

(7) Determine the coloration pattern of the QR code in which the data in the first recording area is recorded.

(8) Determine the coloration patterns of the submodules 3 in the dark modules 2b in which the data in the second recording area is recorded, and create the signature optical code 1.

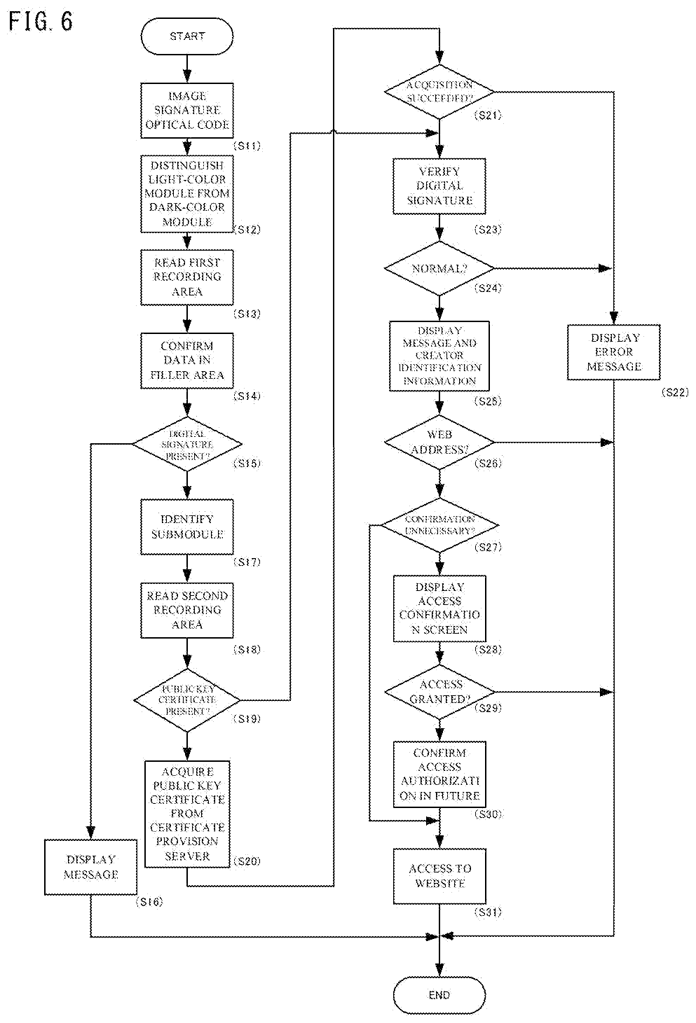

As described above, in this Example, the signature optical code reading authentication device 26 is constructed of the computer in which the dedicated optical code reading authentication program is installed. FIG. 6 is a flowchart illustrating processing contents of the optical code reading authentication program. Such an optical code reading authentication program reads and authenticates the signature optical code 1. In addition, the optical code reading authentication program is configured to be able to execute processing to access a site at the web address when the read message is the web address and the authentication succeeds. Here, in each of the steps in FIG. 6, the image acquisition processing according to the present invention is mainly executed in step S11, the reading processing according to the present invention is mainly executed in steps S12 to S18, the certificate confirmation processing according to the present invention is mainly executed in step S19, the certificate acquisition processing according to the present invention is mainly executed in step S20, the verification processing according to the present invention is executed in step S23, and the reading authentication result output processing according to the present invention is mainly executed in steps S25 to S28.

Details of each of the steps in FIG. 6 are as follows.

S11: Capture an image of the signature optical code 1 by the imaging device that is installed in the computer or the imaging device that is externally connected to the computer so as to acquire the image data.

S12: Identify the signature optical code 1 from the image captured in step S11 and further identify the patterns of the light modules 2a and the dark modules 2b.

S13: Read the data recorded in the first recording area from the identified patterns of the light modules 2a and the dark modules 2b.

S14: Confirm the data recorded in the filler area (particularly, the value of the digital signature flag).

S15: Proceed to step S16 if the digital signature is not recorded, or proceed to step S17 if the digital signature is recorded.

S16: Show the message recorded in the use area of the first recording area on the display screen, and terminate the program.

S17: Identify coloration of the submodules on the basis of the image captured in step S11.

S18: Read the data recorded in the second recording area on the basis of the coloration of the submodules identified in step S16, and the like.

S19: Determine whether the public key certificate that corresponds to the public key ID recorded in the signature optical code 1 has been recorded in the communication terminal, and if the public key certificate has been recorded, proceed to step S23. If the public key certificate has not been recorded, proceed to step S20.

S20: Acquire the public key certificate corresponding to the public key ID from the certificate provision server 23 via the Internet 24, and confirms the validity of the acquired public key certificate with the authentication authority 22. As the web address of the certificate provision server 23, the web address that has been set in the optical code reading authentication program is used.

S21: If the acquisition of the valid public key certificate succeeds in step S20, proceed to step S23. If the acquisition of the valid public key certificate fails, proceed to step S22.

S22: Show the message indicating that the authentication of the signature optical code 1 fails, and terminate the program.

S23: Verify the digital signature recorded in the signature optical code 1 by using the public key certificate so as to authenticate the signature optical code 1. Such authentication is executed by a normal method in the public key infrastructure. That is, the digest of the message is created by using the hash function, and the digest is decoded from the digital signature by using the acquired public key certificate (the public key). Then, by comparing values of the two digests, it is confirmed that the creator of the signature optical code is the owner of the public key certificate and that the message recorded in the signature optical code is not changed.

S24: If the verification result of step S23 is normal, proceed to step S25. If the verification result is abnormal, proceed to step S22.

S25: Show the message recorded in the signature optical code 1 and the identification information (the name, the address, and the like) of the creator recorded in the public key certificate on the display screen.

S26: If the message is the web address (URL), proceed to step S27. If the message is not the web address, terminate the program.

S27: Regarding the public key certificate used for the verification, if the confirmation of the web access is set to be unnecessary, proceed to step S31. If the confirmation of the web access is not set to be unnecessary, proceed to step S28.

S28: Show an access confirmation screen on which it is confirmed whether to access the web address shown on the display screen.

S29: If the access is not permitted in step S28, terminate the program. If the access is permitted, proceed to step S30.

S30: Confirm whether to show the access confirmation screen for the signature optical code 1, which is verified with the same public key certificate, in the future.

S31: Activate a web browser and access the site at the web address recorded in the signature optical code 1.

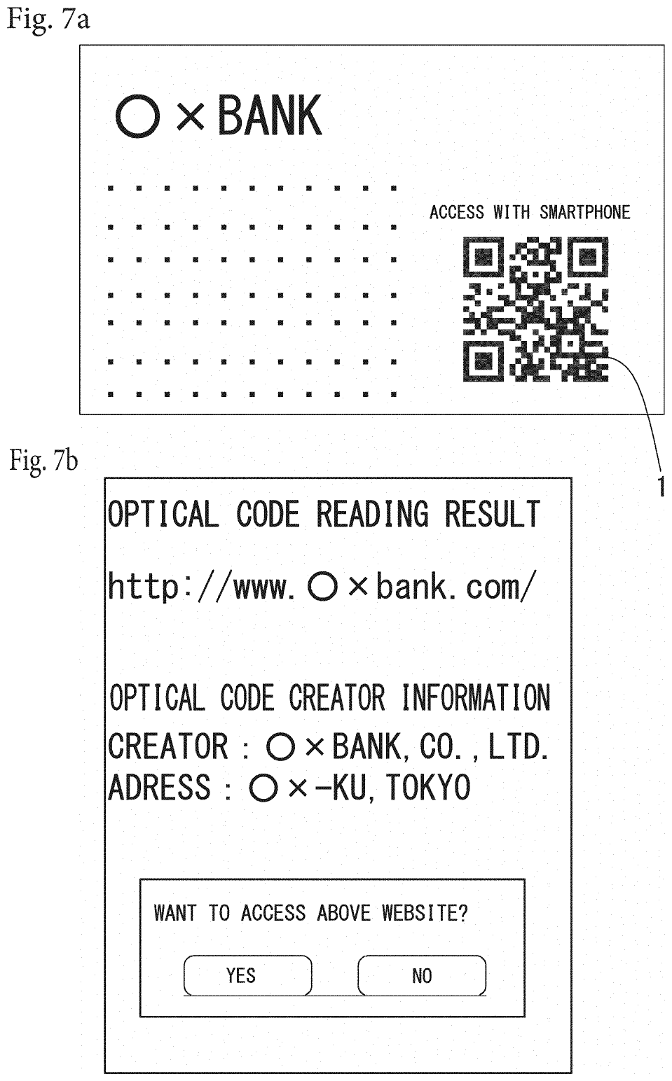

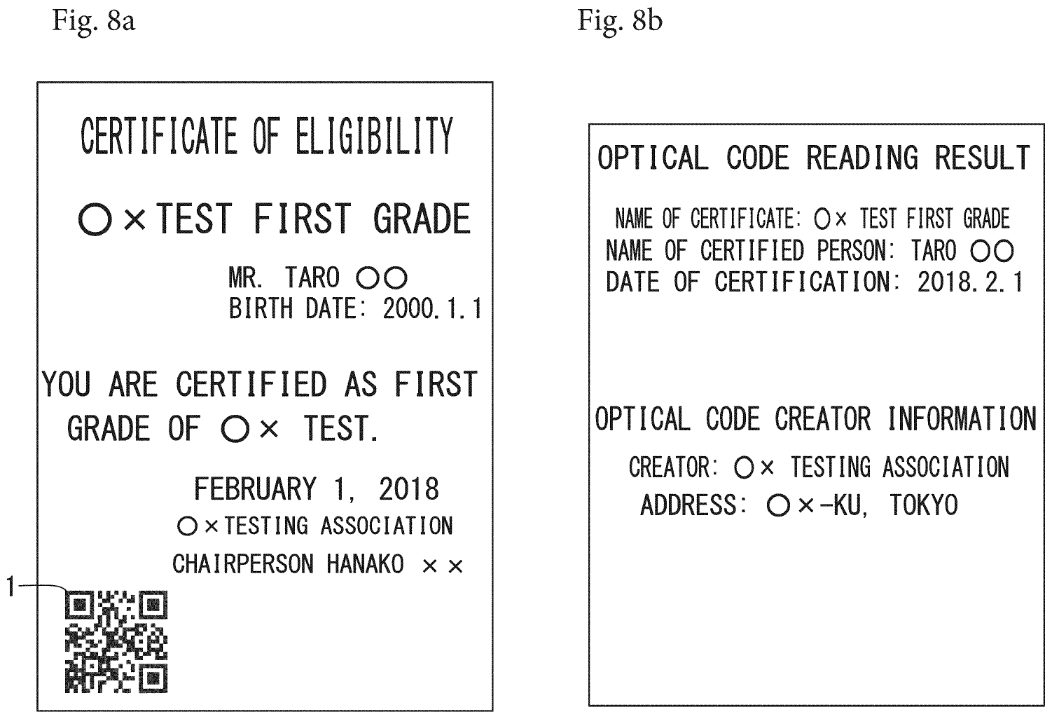

A description will be made on a specific use example of the optical code authentication system in this Example with reference to FIG. 7 and FIG. 8.

FIG. 7(a) is a pamphlet about a bank using the optical code authentication system in this Example. In addition to advertisement information of a ○x BANK, the signature optical code 1 according to this Example is printed on such a pamphlet. In the signature optical code 1, the web address of the creator (the ○x BANK, Co., Ltd.) is recorded as the message, and the digital signature that is created by using the secret key of the creator and the public key ID of the creator are recorded. In the case where the signature optical code 1 in such a pamphlet is read by the signature optical code reading authentication device 26 (the smartphone or the like) according to this Example, the signature optical code 1 is authenticated correctly. Then, as illustrated in FIG. 7(b), the display screen of the signature optical code reading authentication device 26 shows the web address recorded in the signature optical code 1 and the identification information (the name and the address) of the creator, and also shows the confirmation screen to confirm whether to access the web address. If the creator of the signature optical code is an entity other than the ○x BANK, a name other than the ○x BANK is shown as the creator. In such a case, the reader compares characters of the ○x BANK printed on the pamphlet with the name of the creator shown on the display screen. In this way, the reader can confirm that the signature optical code is created by the ○x BANK as an advertiser. Meanwhile, if the web address recorded in the signature optical code is falsified, the verification of the digital signature fails, and the error message is shown. Thus, when the error message is not shown, the reader can understand that the signature optical code is not falsified. As described above, it is possible to improve reliability of the optical code in which the web address is recorded by using the optical code authentication system in this Example. Therefore, it is possible to favorably prevent such an act of guiding to a phishing site by using the optical code, the creator of which is falsified or the optical code in which the web address is changed.

FIG. 8(a) illustrates a certificate of a qualification using the optical code authentication system in this Example. On such a certificate of the qualification, qualification certificate information containing characters and numbers is printed, and the signature optical code 1 according to this Example is also printed. The qualification certificate information includes a name of the qualification, personal information (a name and a birthdate) of the qualified, a qualification certified date, a name and a chairperson of a qualification certifying body. Meanwhile, in the signature optical code 1, as the message, some (the name of the qualification, the name of the qualified, and the qualification certified date) of the qualification certificate information printed on the certificate of the qualification is recorded. In addition, the digital signature, which is created by using the secret key of the creator (the ○x Testing Association) as the qualification certifying body, and the public key ID of the creator are recorded in the signature optical code 1. That is, a production method of such a certificate of the qualification includes: a step of creating the qualification certificate information and the digital signature recorded in the signature optical code 1, the digital signature being based on the secret key of the creator; a step of creating the signature optical code 1 in which the qualification certificate information, the digital signature, and the public key ID of the creator are recorded; and a step of printing the qualification certificate information and the signature optical code 1 on a sheet of paper. The qualification certificate information and the signature optical code 1 may be printed simultaneously or may be printed separately. In the case where the signature optical code 1 that is printed on such a certificate of the qualification is read by the signature optical code reading authentication device 26 (the smartphone or the like) according to this Example, the signature optical code 1 is authenticated correctly. Then, as illustrated in FIG. 8(b), the display screen of the signature optical code reading authentication device 26 shows the name of the qualification, the name of the qualified, and the qualification certified date recorded in the signature optical code 1, and also shows the identification information (the name and the address) of the creator recorded in the public key certificate. Accordingly, by comparing the qualification certificate information printed on the certificate of the qualification with the information shown on the display screen, the reader can confirm that the signature optical code is created by the ○x Testing Association as the qualification certifying body. Meanwhile, in the case where the name of the qualification or the name of the qualified recorded in the signature optical code is falsified, the verification of the digital signature fails, and the error message is shown. Thus, when the error message is not shown, the reader can understand that the signature optical code is not falsified. As described above, it is possible to improve reliability of printed information on the certificate of the qualification by using the optical code authentication system of this Example. Therefore, it is possible to favorably prevent distribution of forged printed articles of various certificates. In this paragraph, the description has been made on the certificate of the qualification as an example. However, this Example is not limited to the certificate of the qualification but can be used for authentication of all types of certificates. Specific examples of the certificates other than the certificate of the qualification are an official document, a residence registry, an agreement, a receipt, an invoice, an authentication seal, a prescription, a mail matter, a credit card, securities, and a cash voucher. For the securities and the cash voucher, a copying prevention function is requested in addition to an anti-counterfeit function. Thus, in the case where this Example is applied to the securities and the cash voucher, instead of the two colors of black and blue, two different types of black with the different infrared light reflective properties are desirably used for the submodules of the dark modules 2b in the signature optical code. This is because, with such a configuration, it is difficult to identify the coloration of the submodules by a general-purpose copier.

### EXAMPLE 2

This Example relates to a payment system to which the optical code authentication system in Example 1 is applied. Thus, a detailed description on the common configuration to Example 1 will not be made.

The payment system in this Example is a type of a system that a payment receiver presents a payment optical code in which payment information is recorded, that a payment terminal of a payer reads the payment optical code and requests a payment server for payment by the payer, and that the payment server mediates the payment between the payer and the payment receiver. In this Example, the signature optical code according to Example 1 is used for such a payment optical code. More specifically, in this Example, the payment receiver is the creator of the payment optical code. Then, in the payment optical code, the payment information of the payment receiver is recorded as the message, the public key ID of the payment receiver is recorded in the filler area of the first recording area, and the digital signature created from the message by using the secret key of the payment receiver is recorded in the second recording area. The payment information of the payment receiver that is recorded in the payment optical code includes a web address of the payment server and a payment ID with which the payment server can specify the payment receiver. Such payment information can also include price of a product or a service as a payment target.

The payment system of this Example includes: the payment optical code; a payment optical code creation device for creating the payment optical code; the payer's payment terminal that can read the payment optical code; the certificate provision server that provides the public key certificate of the payment receiver in response to a request from the payment terminal; and the payment server that takes care of the payment between the payer and the payment receiver in response to a request from the payment terminal.

The certificate provision server is the same as the certificate provision server in Example 1. In addition, the payment optical code is the signature optical code according to Example 1. Thus, the payment optical code creation device is constructed of the signature optical code creation device according to Example 1, that is, the computer in which the optical code creation program is installed. The payment terminal of the payer is constructed of a computer in which a dedicated payment program is installed and the payment information of the payer is stored. More specifically, the communication terminal, such as the smartphone, having the communicating function and the imaging function is preferred as the payment terminal. A detailed description on the payment program will be made below. The payment information of the payer includes the payment ID with which a payment agent can specify the payer. The payment server is constructed of an existing server operated by the payment agent. Here, the payment system in this Example allows payment using any of the plural payment agents.

As the payment system in this Example, first, similar to Example 1 (see FIG. 4), before creating the payment optical code, the payment receiver (the creator) causes the payment optical code creation device to store the own secret key and the own public key ID. That is, the payment receiver acquires the own public key certificate and the own secret key from the authentication authority, requests the certificate provision server for the registration of the own public key certificate, and acquires the own public key ID from the certificate provision server.

Next, the payment receiver acquires the payment information to be recorded in the payment optical code. That is, the payment receiver requests the payment agent to take care of the payment by sending own personal information (the name, the address, a bank account, and the like), and acquires the web address of the payment server and the own payment ID from the payment agent. In the case where the authentication authority and the operating business of the certificate provision server are the same as the payment agent, an acquisition procedure of the payment information and an acquisition procedure of the secret key and the public key ID can be executed all at once.

The payment receiver creates the payment optical code, in which the acquired payment information is recorded, by using the payment optical code creation device and presents a printed article on which the payment optical code is printed to a payment place at a store. Then, a user (the payer) of the store causes the own payment terminal to read the payment optical code presented at the store during the payment and requests the payment server to mediate the payment. Here, in this Example, prior to access to the payment server, the payment terminal requests the user (the payer) to confirm the payment receiver. More specifically, similar to Example 1, the payment terminal verifies the digital signature recorded in the payment optical code. Then, in the case where the verification result is normal, the payment terminal shows the identification information of the payment receiver, which is recorded in the public key certificate of the payment receiver (the creator), on the display screen, and also shows a confirmation screen to confirm whether to make payment to the payment receiver.

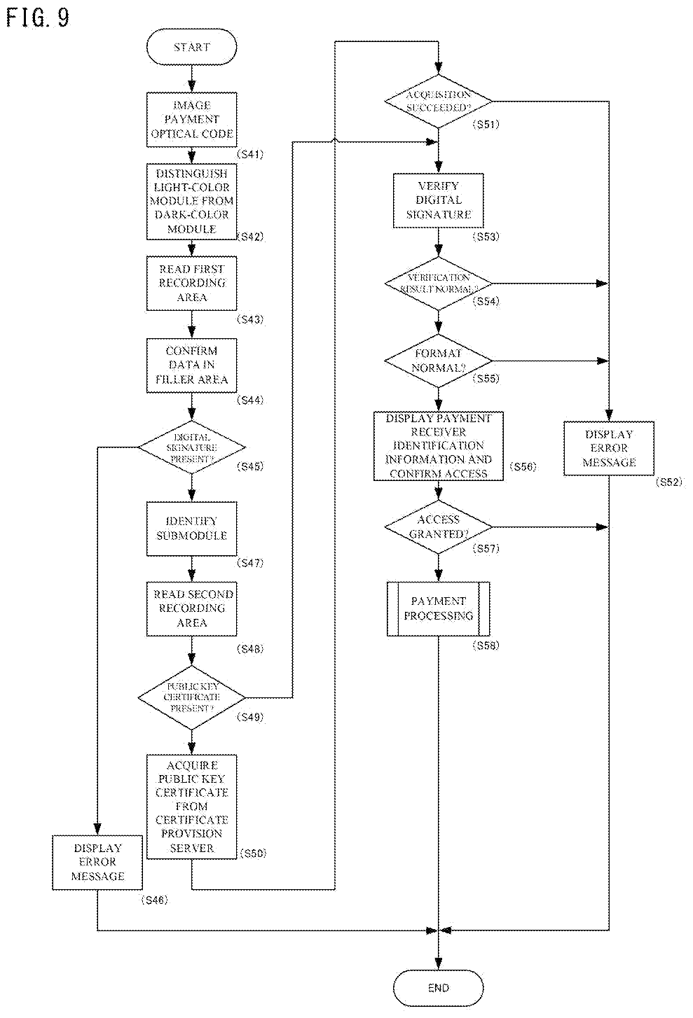

FIG. 9 is a flowchart illustrating processing contents of the payment program that is installed in the payment terminal.

In each of the steps of FIG. 9, the public key acquisition means according to the present invention is mainly implemented in step S50, the authentication means according to the present invention is mainly implemented in step S53, and details of each of the steps in FIG. 9 are as follows.

S41: Image the payment optical code by the imaging device installed in the payment terminal or the imaging device externally connected to the communication terminal.

S42: Identify the payment optical code from the image captured in step S41 and further identify the patterns of the light modules 2a and the dark modules 2b.

S43: Read the data recorded in the first recording area from the identified patterns of the light modules 2a and the dark modules 2b.

S44: Confirm the data recorded in the filler area (particularly, the value of the digital signature flag).

S45: Proceed to step S46 if the digital signature is not recorded, or proceed to step S47 if the digital signature is recorded.

S46: Display the message indicating that the authentication of the payment optical code fails, and terminate the program.

S47: Identify the coloration of the submodules on the basis of the image captured in step S41.

S48: Read the data recorded in the second recording area on the basis of the coloration of the submodules identified in step S46, and the like.

S49: If the public key certificate that corresponds to the public key ID recorded in the payment optical code has been recorded in the communication terminal, proceed to step

S53. If the public key certificate has not been recorded, proceed to step S50.

S50: Acquire the public key certificate corresponding to the public key ID from the certificate provision server via the Internet, and confirm the validity of the acquired public key certificate with the authentication authority. As the web address of the certificate provision server, the web address that has been set in the payment program is used.

S51: If the acquisition of the valid public key certificate succeeds in step S50, proceed to step S53. If the acquisition of the valid public key certificate fails, proceed to step S52.

S52: Display the message indicating that the authentication of the payment optical code fails, and terminate the program.

S53: Verify the digital signature recorded in the payment optical code by using the public key certificate so as to authenticate the payment optical code. Such authentication is executed by the normal method in the public key infrastructure. That is, the digest is created from the message by using the hash function, and the digest is decoded from the digital signature by using the acquired public key certificate (the public key). Then, by comparing values of the two digests, it is confirmed that the creator of the payment optical code is the owner of the public key certificate and that the identification information of the payment receiver recorded in the payment optical code is not changed.

S54: If the verification result of step S54 is normal, proceed to step S55. If the verification result is abnormal, proceed to step S52.

S55: If the message satisfies a format of the payment information, proceed to step S56. If the message does not satisfy the format of the payment information, proceed to step S52.

S56: Show the access confirmation screen, on which the user confirms access to the payment server, on the display screen of the payment terminal.

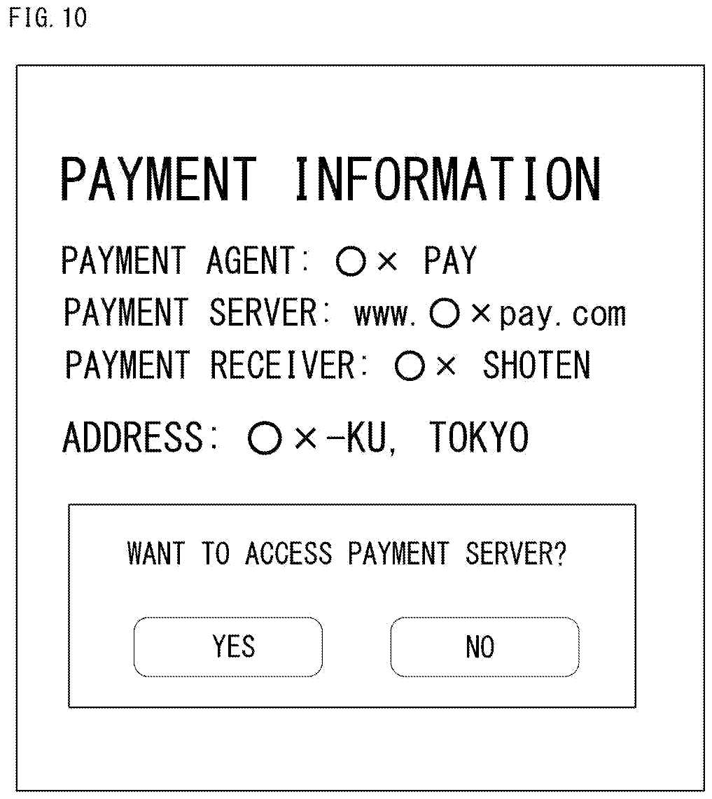

As illustrated in FIG. 10, on the access confirmation screen, the payment agent, the payment server, and the name and the address of the payment receiver are shown, and the message for confirming whether to access the payment server is also shown. The payment server is included in the payment information recorded in the payment optical code. A name of the payment agent is linked and stored with the address of the payment server in the payment program in advance. If the name of the payment agent is not stored, “unknown” is shown. As the name and the address of the payment receiver, those recorded as owner information in the public key certificate are shown. Just as described, in the payment system in this Example, the payer can confirm the payment agent and the payment receiver prior to the access to the payment server by using the payment terminal.

S57: If the user does not permit the access in step S56, terminate the program. If the user verifies the access, proceed to step S58.

S58: Execute payment processing. That is, the payer, the payment ID of the payment receiver, and an amount of the payment are sent to the payment server recorded in the payment optical code, and the payment to the payment receiver is requested. The payment processing with the payment server can be executed by a normal method.

As it has been described so far, in the payment system of this Example, before the payer accesses the payment server by using the payment terminal, the identification information of the creator (the payment receiver) in the payment optical code can be confirmed. Thus, compared to the conventional payment system, a further safe financial transaction can be made. In addition, the payment program according to the payment system in this Example can handle the plural payment agents. Thus, the payer can avoid the trouble of selecting and activating the payment program for each of the payment agents.

The present invention is not limited to the configurations in above Examples, and various modifications can be made to the configurations in above Examples within the scope that does not depart from the gist of the present invention. For example, in the above Example, the signature optical code is compatible with the QR code. However, the signature optical code according to the present invention may be compatible with the optical code in a standard other than the QR code or may not be compatible with the optical codes in existing standards.

In the signature optical code according to above Example, the message and the public key ID are recorded in the first recording area, and the digital signature is recorded in the second recording area. However, in the signature optical code according to the present invention, the areas where the message, the public key ID, and the digital signature are recorded are not particularly limited. The signature optical code according to the present invention is not limited to that equipped with the expanded area (the second recording area).

The optical code authentication system and the payment system in above Examples use the authentication authority in the public key infrastructure. However, the secret key, the public key, and the public key certificate according to the present invention are not limited to those issued by the authentication authority but may be created by the creator of the signature optical code.

The optical code authentication system in above Example is configured that the web address of the certificate provision server is set in the optical code reading authentication program in advance and that the public key certificate is requested for the certificate provision server at the web address. However, instead of such a configuration, information with which the certificate provision server providing the public key certificate can be specified may be recorded in the signature optical code. Here, such information may be included in the public key ID or may separately be recorded from the public key ID in the signature optical code.

In above Example 1, the signature optical code reading authentication device 26 reads and authenticates the signature optical code 1. However, it may be configured that two devices of the reading device and an authentication device may have the functions of the signature optical code reading authentication device 26. That is, with such a configuration, the reading device reads the signature optical code 1 and outputs the data (the message, the digital signature, and the public key ID) recorded in the signature optical code 1 to the authentication device. Then, the authentication device authenticates the signature optical code 1 on the basis of the output data and outputs the authentication result.

### DESCRIPTION OF REFERENCE NUMERALS

1/ Signature optical code

2a/ Light module

2b/ Dark module

3/ Submodule

20/ Creator

21/ Signature optical code creation device

22/ Authentication authority

23/ Certificate provision server

24/ Internet

25/ Reader

26/ Signature optical code reading authentication device

1. An optical code creation program for causing a computer to execute:
digital signature creation processing to create an digital signature from a message by using a secret key of a creator of an optical code; and
optical code creation processing to create the optical code in which
the message,
the digital signature, and
a public key ID with which a public key certificate of the creator can be specified and which is smaller in size than the public key certificate are recorded, the public key certificate including a public key that is paired with the secret key.

2. The optical code creation program according to claim 1, wherein
the optical code includes a light module identified in a light color and a dark module identified in a dark color,
at least a part of the light module and the dark module is a multivalued module that can store two or more bits by having plural types of light reflective properties and/or by being subdivided into minute areas,
the optical code includes: a first recording area where data is recorded in a pattern of the light module and the dark module; and a second recording area where data is recorded in a pattern of the multivalued module, and
in the optical code creation processing,
the digital signature is recorded in the second recording area, and
the message and an index indicating that the digital signature is recorded in the second recording area are recorded in the first recording area.

3. The optical code creation program according to claim 2, wherein
the dark module is subdivided into plural submodules,
each of the plural submodules is in one of plural types of dark colors with the different light reflective properties, and
in the second recording area, the data is recorded according to a coloration pattern of the submodules.

4. The optical code creation program according to claim 2, wherein
the optical code includes: a variable area where a pattern of the light module and the dark module varies by the data recorded in the first recording area; and a fixed area where the pattern of the light module and the dark module is determined in advance and which constitutes a pattern assisting with optical reading,
the second recording area has: a variable second recording area where the data is recorded according to a coloration pattern of the submodules in the dark module included in the variable area; and a fixed second recording area where the data is recorded according to a coloration pattern of the submodules in the dark module included in the fixed area, and
in the optical code creation processing,
the data and error correction data of said data are recorded in each of the variable second recording area and the fixed second recording area, and
sizes of the data and the error correction data, which are recorded in each of the variable second recording area and the fixed second recording area, are recorded in an area where the message is not recorded in the first recording area.

5. The optical code creation program according to claim 4, wherein
the error correction data is a Reed-Solomon code, and
in the optical code creation processing,
the size of the error correction data recorded in each of the variable second recording area and the fixed second recording area is determined according to recordable size of the error correction data in each of the variable second recording area and the fixed second recording area so as to maximize correction capability.

6. A program for causing a computer to read an optical code in which a message, an digital signature created from the message by using a secret key of a creator of the optical code, and a public key ID with which a public key certificate of the creator including a public key paired with the secret key can be specified are recorded, the optical code reading authentication program for causing the computer to execute:
image acquisition processing to acquire image data of the optical code that is captured by an imaging device installed in or connected to the computer;
reading processing to read the message, the digital signature, and the public key ID recorded in the optical code on the basis of the image data acquired in the image acquisition processing;
certificate acquisition processing to acquire the public key certificate from a specified certificate provision server via a communication line on the basis of the public key ID read in the reading processing;
verification processing to verify the digital signature recorded in the optical code on the basis of the public key certificate that corresponds to the public key ID recorded in said optical code; and
reading authentication result output processing to output the message and identification information of the creator included in the public key certificate in the case where it is determined that the digital signature is normal in the verification processing.

7. A program for causing a computer to read an optical code in which a message, an digital signature created from the message by using a secret key of a creator of the optical code, and a public key ID with which a public key certificate of the creator including a public key paired with the secret key can be specified are recorded, the optical code reading authentication program for causing the computer to execute:
image acquisition processing to acquire image data of the optical code that is captured by an imaging device installed in or connected to the computer;
reading processing to read the message, the digital signature, and the public key ID recorded in the optical code on the basis of the image data acquired in the image acquisition processing;
certificate confirmation processing to determine whether the public key certificate that corresponds to the public key ID read in the reading processing is stored in a storage of the computer;
verification processing to verify the digital signature recorded in the optical code on the basis of the public key certificate that corresponds to the public key ID recorded in said optical code; and
reading authentication result output processing to output the message and identification information of the creator included in the public key certificate in the case where it is determined that the digital signature is normal in the verification processing.

8. The optical code reading authentication program according to claim 6, wherein
in the case where the message includes a web address,
in the reading authentication result output processing, the web address and the identification information of the creator included in the public key certificate are output to a display screen of the computer, and a user of the computer confirms whether to access the web address.

9. (canceled)

10. An optical code authentication system comprising:
a reading device that reads an optical code in which a message, an digital signature created from the message by using a secret key of a creator of the optical code, and a public key ID with which a public key certificate of the creator including a public key paired with the secret key can be specified are recorded, and that outputs the read message, the read digital signature, and the read public key ID; and
an authentication device that receives the message, the digital signature, and the public key ID output from the reading device and authenticates the optical code, wherein
the authentication device has:
a function of acquiring, from a specified certificate provision server, the public key certificate that corresponds to the public key ID via a communication line and verifying the digital signature recorded in the optical code by using said public key certificate; and
a function of outputting identification information of the creator included in the public key certificate in the case where a verification result of the digital signature is normal.

11. A payment system comprising:
a payment server;
a payment optical code in which payment information of a payment receiver is recorded; and
a payment terminal of a payer that stores payment information of the payer, reads the payment optical code, and requests the payment server for payment from the payer to the payment receiver, wherein
in the payment optical code, the payment information of the payment receiver, an digital signature that is created from the payment information of the payment receiver by using a secret key of the payment receiver, and a public key ID with which a public key certificate of the payment receiver including a public key paired with the secret key can be specified are recorded,
a certificate provision server is provided to link and store the public key certificate with the public key ID and, in response to a sending request from the payment terminal, send the public key certificate that corresponds to the public key ID included in said sending request to said payment terminal, and
the payment terminal
can read the payment optical code, and includes:
public key acquisition means capable of acquiring the public key certificate, which corresponds to the public key ID read from the payment optical code, from the certificate provision server via a communication line;
authentication means that authenticates the payment optical code on the basis of the digital signature and the payment information of the payment receiver that are recorded in said payment optical code and on the basis of the public key certificate that corresponds to the public key ID recorded in said payment optical code;
receiver information showing means that shows identification information of the payment receiver included in the public key certificate on a display screen and requests confirmation of said payment receiver in the case where the authentication means authenticates the payment optical code correctly; and
payment request means capable of requesting the payment server for payment to the payment receiver in the case where the payer approves the payment receiver shown by the receiver information showing means.

12. A printed article production method comprising:
a step of creating an digital signature from printing data that is printed on a printing target by using a secret key of a creator of an optical code;
a step of creating an optical code in which the printing data, the digital signature, and a public key ID with which a public key certificate of the creator including a public key paired with the secret key can be specified and which is smaller in size than the public key certificate are recorded;
a step of printing the printing data on the printing target; and
a step of printing the optical code on the printing target.

13. An optical code authentication method comprising:
a step of linking and registering a public key ID with a public key certificate in a certificate provision server;
a step of creating an digital signature from a message by using a secret key of a creator;
a step of creating an optical code in which the message, the digital signature, and the public key ID with which a public key certificate of the creator including a public key paired with the secret key can be specified and which is smaller in size than the public key certificate are recorded;
a step of producing a printed article added with the optical code;
a step of disclosing the printed article;
a step of causing a computer to read the message, the digital signature, and the public key ID recorded in the optical code;
a step of causing the computer to request the certificate provision server for the public key certificate, which corresponds to the public key ID read from the optical code, via a communication line;
a step of causing the certificate provision server to send the public key certificate to the computer via the communication line;
a step of causing the computer to determine whether the optical code is created by an owner of the public key certificate on the basis of the digital signature and the message recorded in said optical code and on the basis of the public key certificate; and
a step of causing the computer to output the message and identification information of the creator included in the public key certificate in the case where it is determined that the optical code is created by the owner of the public key certificate.

14. The optical code authentication method according to claim 13, wherein
the message is a web address.

15. The optical code authentication method according to claim 13, wherein
the message includes a part or a whole of characters and/or numbers printed on the printed article.

16. The optical code authentication method according to claim 13, wherein
the message is payment information of a payment receiver.
